(19) United States
(12) Patent Application Publication
(10) Pub. No.: US 2024/0133250 A1
(43) Pub. Date: Apr. 25, 2024

(54) DOWNHOLE CABLE

(71) Applicant: WIRES&BYTES GMBH, Berlin (DE)

(72) Inventors: Petar BASIC, Berlin (DE); Saeed REHMAN, Berlin (DE)

(21) Appl. No.: 18/278,050

(22) PCT Filed: Feb. 23, 2022
(86) PCT No.: PCT/EP2022/054570

§ 371 Date: Aug. 20, 2023

(30) Foreign Application Priority Data
Feb. 23, 2021 (GB) 2102527.5

(51) Int. Cl. E21B 17/20; G02B 6/44

(52) U.S. Cl. CPC E21B 17/206; G02B 6/4432; G02B 6/4486

(57) ABSTRACT

The invention provides a cable for use in a wellbore. The cable comprises a core and an armor layer surrounding the core. The armor layer comprises a plurality of segments. Each segment is configured to be axially displaceable along a longitudinal axis of the cable relative to one another.

The present invention relates to equipment for the oil and gas industry including equipment for drilling of production wells and well intervention operations and in particular to downhole cable apparatus capable of supporting and/or communicating and monitoring with downhole equipment in a well. The present invention also relates to a method of manufacturing a downhole cable.

### BACKGROUND TO THE INVENTION

During drilling of a production well a drill string penetrates the earth and creates a wellbore which that passes through various reservoir formations. After drilling the wellbore, the drill string is removed from the wellbore and various downhole devices may be positioned at desired locations in the wellbore such as packers, plug, valves etc during the completion and production stages of the well.

During the life of the well, intervention operations may be performed on the well by lowering downhole devices into the well to monitor and conduct remedial work. Typically, a downhole device is lowered downhole on a cable system such as slickline or wireline to a desired depth. The downhole device may be set in place and cable system retrieved to surface or the cable system may stay downhole during the downhole operation.

A traditional slickline is a single strand core cable encased within a polymer outer coating. Traditional slicklines do not have a conductor. They are typically used for mechanical operations during well construction, mechanical operations, and maintenance such a well bore cleaning, valve installation, and fishing operations.

A traditional wireline is a conductive cable having either a single or multi-conductor cable surrounded by a support member and encased within a polymer outer coating. The conductor cable is capable of transmitting power to downhole devices and transmitting data to and from the surface. Wirelines are typically used in perforating, plug setting, well logging and production monitoring operations.

Slicklines and wirelines may additionally include a fiber optic bundle for communication and monitoring along the cable.

Wellbores may be vertical, horizontal, or deviated bores and it can be difficult installing downhole device in sections along the wellbore due to the weight of the device and the weight of cable system. The operator must overcome static friction between the cable and the wellbore. This is a particular issue with horizontal, highly deviated, and long reaching bores where thousands of metres of cable may be required.

### SUMMARY OF THE INVENTION

It is an object of an aspect of the present invention to obviate or at least mitigate the foregoing limitations of existing cable system technology.

It is another object of an aspect of the present invention to provide a lightweight, flexible, and robust cable apparatus and method of use.

It is a further object of an aspect of the present invention to provide cable apparatus and which is configured for use in slickline and wireline applications.

Further aims of the invention will become apparent from the following description.

According to a first aspect of the invention, there is provided a cable for a wellbore, comprising:
a core; and
an armor layer surrounding the core;
wherein the armor layer comprises at least one fiber reinforced composite material and
wherein the armor layer comprises a plurality of segments.

The cable may be a slickline, wireline, electrical cable, a non-electrical cable and/or an optical fiber cable.

The core may be a solid core. The core may be a hollow core. The core may comprise at least one conductor. The core may comprise at least one optical fiber. The core may comprise at least one conductor and at least one optical fiber. The at least one conductor may be an electrical conductor. The core may comprise at least one tube or tubular element. The at least one tube or tubular element may be an inner tube element. The at least one tube or tubular element may be made from a metal or plastic material. The at least one tube or tubular element may be made from steel, copper, or other materials. The at least one tube or tubular element may surround or at least partially surround the at least one conductor and/or the at least one optical fiber. Each of the segments may abut the at least one tube or tubular element.

The armor layer may have an outer diameter in the range of 2.5 mm to 30 mm. The armor layer may have an outer diameter in the range of 3.2 mm to 10 mm.

The cable may comprise an electrical forward path. The electrical forward path may comprise the armor layer and/or the core. The electrical forward path may comprise at least one segment of the armor layer and/or the core. The electrical forward path may comprise at least one component of the armor layer and/or at least one component of the core. The electrical forward path may comprise the armor layer or at least one segment of the armor layer.

The electrical forward path may have a resistance range from 1×10⁻⁷ Ω·m to 5000×10⁻⁷ Ω·m (Ohm meter). The electrical forward path may have a resistance range from 10×10⁻⁷ Ω·m to 1000×10⁻⁷ Ω·m (Ohm meter).

The plurality of segments may comprise two or more segments. Each of the segments may be configured to move along a longitudinal axis of the cable relative to one another. Each of the segments may be configured to move along a longitudinal axis of the core. The armor layer comprises two or more segments. The segments may be selected from rods, strips, straps, wires, filaments and/or fibers.

Each segment may have a suitable polygon profile or cross sectional shape. The segments may be flat. The segments may have a keystone, square, circular, rectangular, or wedged shape profile or cross section. The segments may have a round, non-circular or arc shape. The cable may have a circular cross section profile. The cable may have a cross section profile of any suitable shape. The cable may have a maximum outer diameter of up to 50 mm. The cable may have an outer diameter in the range of 3 mm to 35 mm. The cable may have a maximum outer diameter of up to 15 mm. The cable may have a maximum outer diameter of up to 10 mm. The cable may have an outer diameter up to 8 mm. The cable may have a maximum outer diameter of up to 7.5 mm.

The segments of the armor layer may be straight. The armor layer may be wrapped around the core. The plurality of segments may be arranged around the core. The plurality of segments may be arranged and/or orientated parallel with the longitudinal axis of the cable and/or the core. The plurality of segments may be arranged helically around the core. The plurality of segments may be arranged helically stranded around the core. The plurality of segments may be arranged around the core in any suitable configuration.

The plurality of segments may have a low coefficient of friction. The segments may be made of fiber reinforced composite material. The segments may have reinforcement members made of fiber reinforced composite material.

The fiber reinforced composite material may be provided in the form of at least one reinforcement member in one of more the segments. The longitudinal axis of the at least one reinforcement member may be arrangement generally parallel with the longitudinal axis of the one or more segments, the core, and/or the longitudinal axis of the cable.

The segments may comprise a polymer composition. The segments may comprise a copolymer, fluoropolymer, silicone, ceramic, natural mineral buffer materials and/or fiber reinforced composite material.

The armor layer may comprise and/or consist of a non-metallic material. The non-metallic material may be selected from the group comprising carbon-fiber, carbon-tube composite materials, graphite, graphene, graphite and graphene based composite materials, and/or mineral fiber composites such as basalt. The armor layer may comprise and/or consist of a non-crystalline material.

The at least one fiber reinforced composite material may be non-metallic. The at least one fiber reinforced composite material may be an electrically conductive material. The at least one fiber reinforced composite material may be non-crystalline. The fiber reinforced composite material may be selected from carbon fiber, basalt fiber, natural mineral fiber, graphene, aramid fiber, or Kevlar fiber-based material. The fiber reinforced composite material may be resin impregnated. The fiber reinforced composite material may be configured for spatial efficiency in the cross section. By spatial efficiency it is meant that the space in the cross-section is filled with as much fibrous material possible in that space to avoid voids.

Each of the segments may comprise the same composite material. Each of the segments may comprise the same fiber reinforced composite material. The plurality of segments may comprise segments made from different fiber reinforced composite material. The armor layer may comprise segments made of different composite material and/or different fiber reinforced composite material. Each of the segments may comprise the same material. Each segment may have the same electrical conductance and resistance properties.

The armor layer may comprise a plurality of segments made of a fiber reinforced composite material having one tensile elasticity or Young's modulus. The armor layer may comprise a plurality of segments made of a fiber reinforced composite material having a tensile elasticity or Young's modulus in the range of 50 to 500 GPa.

The armor layer may comprise a mixture of segments made of different materials. The armor layer may comprise a mixture of segments made of different materials with each segment type having a set tensile elasticity or Young's modulus value. The armor layer may comprise a plurality of segments made of at least one segment type. The armor layer may comprise a plurality of segments made of one material and/or fibrous composition. The different materials may have different electrical conductance and resistance properties.

The armor layer may comprise segments of two or more fiber reinforced composite material. The two or more fiber reinforced composite materials may have a different tensile elasticity or Young's modulus values from one another. The tensile elasticity or Young's modulus values may be in the range of 50 to 500 GPa.

The segments may be a hybrid of two or more materials. The segments may be made of a polymer material with reinforcement members comprising fiber reinforced composite material.

The fiber reinforced composite material may be a hybrid of two or more fiber reinforced materials each having a different tensile elasticity or Young's modulus. One or more of the segments may comprise a hybrid of two or fiber reinforced materials.

The armor layer may be electrically conductive. The armor layer may comprise an electrically conductive material. The electrically conductive material may be a non-metallic material. The electrically conductive material may be a non-crystalline material. The armor layer and/or at least one segment of the armor layer may possess electrical properties for conducting electricity such as low resistance and/or low inductance. The armor layer may comprise at least one conductor. At least one of the segments of the armor layer may be electrically conductive. The armor layer may comprise at least one conductor in one or more of the segments. The armor layer may comprise at least one first segment comprising a first material and/or fibrous composition and at least one second segment comprising a second material and/or fibrous composition.

The armor layer may comprise a plurality of first segments and a plurality of second segments. The first segments may be made of a first material and/or first fibrous composition and the second segment made of a second material and/or second fibrous composition. The first material and/or first fibrous composition may be different to the second material and/or second fibrous composition.

The first and second segments may be arranged in an alternating arrangement on an outer surface of the at least one tube element. The first and second segments may be arranged in an alternating arrangement along the length of the cable.

The armor layer may comprise a plurality of third and/or further segments. The third and/or further segments may be made of a third or further material and/or third or further fibrous composition. The third or further material and/or third or further fibrous composition may be different to the first and/or second material and/or first and/or second fibrous composition. The third and/or further segments may comprise electrically conductive elements such as conductive wires for power and communication purposes. The third and/or further segments may comprise conductors in a stranded layer.

The first, second, third and/or further segments and may be arranged in an alternating arrangement on an outer surface of the at least one tube element. The first, second, third and/or further segments may be arranged in an alternating arrangement along the length of the cable.

One or more of the segments may comprise a reinforcement member. The reinforcement member may provide strength to the segments, armor layer and/or cable. The reinforcement member may be selected from the group comprising a conductor, plastic rod or wire, metal rod or wire, carbon rod, steel rod, steel wire, fiber reinforced composite material, and/or basalt rod.

The armor layer may comprise at least one first segment comprising a first segment material and at least one second segment comprising a second segment material. The at least one first segment and/or the at least one second segment may comprise at least one reinforcement member. The at least one first segment may comprise at least one first reinforcement member comprising a first reinforcement member material. The at least one second segment may comprise at least one second reinforcement member comprising a second reinforcement member material. Any of the first segment material, second segment material, first reinforcement member material and/or second reinforcement material may comprise at least one fiber reinforced composite material.

The first segment material, second segment material, first reinforcement member material and/or second reinforcement material may comprise an electrically conductive material. The electrically conductive material may be a non-metallic material. The electrically conductive material may be a non-crystalline material.

Each segment may be axially displaceable along a longitudinal axis of the cable relative to one another. Each segment may be comprised of a high tensile strength, high elastic modulus and/or low weight fibrous material. Each segment may have a material density in the range of 100 kg/m3 to 20000 kg/m3. Each segment may have a material density in the range of 500 kg/m3 to 10000 kg/m3.

The segments may be assembled into a tube or layer surrounding the core. The segments may be assembled into a hollow tube or hollow layer surrounding the core. The assembled armor layer may have an inner diameter and an outer diameter. The inner diameter of the armor layer may be equal to or greater to the outer diameter of the inner tube element. The assembled armor layer may surround the tube element. The assembled armor layer may have an outer diameter equal to or less than the inner diameter of the outer tube element. The outer tube element may surround the assembled armor layer. The outer tube element may have an outer diameter which is equal to or less than an inner diameter of an outer polymeric layer. The outer polymeric layer may surround the outer tube element.

The core may be configured to convey electrical power and/or optical signals. The core may be configured to convey data and/or power for communication, monitoring, distributed measurement, signalling and power delivery. The core may comprise at least one conductor and or at least one optical fibre. The at least one conductor may be insulated or non-insulated. The at least one conductor may be insulated or non-insulated copper wires. The core may comprise a tube. The tube may surround or at least partially surround the least one conductor and or at least one optical fibre. The tube may be made of metal. The tube may be made of steel or copper. The tube may be made of conductive, semi-conductive or non-conductive material. The tube may be hollow and empty.

The plurality of the segments may not be bonded to the core. The plurality of the segments may be free to move relative to the core. Each of the segments may not bonded to one another. Each of the segments may be free to move relative to one another. The layers of the cable from the core to the outer jacket may not be bonded to one another. By providing a cable where the layers from the core to outer surface of the cable are not bonded may provide flexibility.

The cable may comprise at least one electrical insulator layer. The cable may comprise at least two concentric co-axial electrical parts. The at least two concentric co-axial electrical parts may comprise at least one electrical forward path and at least one electrical return path. The at least one electrical forward path and at least one electrical return path may be electrically isolated from one another by at least one electrical insulator layer. The at least one electrical insulator layer may be located between the core and the armor layer. The at least one electrical insulator layer may surround an inner surface and/or an outer surface of the armor layer. Preferably the cable comprises two concentric co-axial electrical parts which may comprise one electrical forward path and one electrical return path. The at least one electrical insulator layer may comprise a polymeric material. The material of the electrical insulator layer may be selected from the group comprising polymer, resin, polyethylene, polyimide, polyamide, fluorinated ethylene propylene, ethylene-tetrafluoroethylene, polytetrafluoroethylene, polyether ether ketone, polyvinylidene fluoride, and/or polyvinylidene difluoride. The at least one electrical insulator layer may comprise any suitable insulation material that may be extruded and attached to or taped to carbon or carbon-based material.

The cable may comprise at least one fixation or bundling element such as tape, film, or jacket. The fixation or bundling element may be made of plastic. The fixation or bundling element may act as an electrical insulator layer.

The cable may comprise at least one outer tube element surrounding the plurality of segments. The at least one outer tube element may be configured to provide further protection and may prevent or mitigate gas/liquid ingress. The at least one outer tube element may be electrically conductive. The at least one outer tube element may comprise an electrically conductive material. The electrically conductive material may be a metallic material. The electrically conductive material may be a crystalline material. The electrically conductive material may be a non-metallic material. The electrically conductive material may be a non-crystalline material. The at least one outer tube element may possess electrical properties for conducting electricity such as low resistance and low inductance. The at least one electrical insulator layer may be located between the armor layer and the at least one outer tube element. The at least one electrical insulator layer may surround an outer surface of the armor layer and/or an inner surface of the outer tube element.

The cable may comprise an electrical return path. The electrical return path may comprise at least one outer tube element. The at least one outer tube element may be an outer encapsulation tube. The electrical return path may comprise a resistance range from 1×10⁻⁷ Ω·m to 100×10⁻⁷ Ω·m (Ohm meter). The electrical return path may comprise a resistance range from 1×10⁻⁷ Ω·m to 10×10⁻⁷ Ω·m (Ohm meter).

The at least one outer tube element may be made of metal or plastic. The at least one outer tube element may be made of plastic with at least one conductor embedded or associated with the at least one outer tube element. The at least one outer tube element may be made of metal. The metal of the at least one outer tube element may be selected from the group comprising copper, steel, stainless steel, steel alloy, chromium-nickel stainless steel, chromium-nickel stainless steel alloy containing molybdenum, titanium or copper, nickel and/or nickel alloy.

The cable may have two or more outer tube elements. A first outer tube element may surround or at least partially surround the armor layer, at least one electrical insulator layer, and/or the fixation or bundling element. A second outer tube element may surround or at least partially surround the first outer tube element. Preferably the first outer tube is made from metal such as steel and the second outer tube is made from plastic such as a polymer material.

The cable may be a mono cable, coaxial cable, hepta cable or any other suitable cables with any core configuration.

According to a second aspect of the invention, there is provided a cable for a wellbore, comprising:
a core; and
an armor layer surrounding the core;
the armor layer comprises at least one fiber reinforced composite material;
wherein the armor layer comprises a plurality of segments configured to move along a longitudinal axis of the cable relative to one another.

The cable may be wireline or slickline cable. The cable may be a mono cable, coaxial cable, hepta cable or any other suitable cables with any core configuration.

The cable may comprise an electrical forward path and/or an electrical return path. The electrical forward path may provide a forward path for current and/or signals to be transmitted to a target device along the cable. The electrical return path may provide a return path for current and/or signals to return to the source and/or ground the cable.

The electrical forward path may comprise the core and/or armor layer. The electrical forward path may comprise at least a component of the core and/or at least a component of armor layer. The electrical forward path may comprise the armor layer. The electrical forward path may comprise at least one segment of the armor layer. The cable may comprise at least one outer tube element. The electrical return path may comprise the at least one outer tube element. The cable may comprise at least one electrical insulator layer. The at least one electrical insulator layer may be located between the armor layer and the at least one outer tube element.

Embodiments of the second aspect of the invention may include one or more features of the first aspect of the invention or its embodiments, or vice versa.

According to a third aspect of the invention, there is provided a slickline cable for a wellbore, comprising:
a core; and
an armor layer surrounding the core;
the armor layer comprises at least one fiber reinforced composite material;
wherein the armor layer comprises a plurality of segments configured to move along a longitudinal axis of the cable relative to one another.

The cable may comprise an electrical forward path and/or an electrical return path. The electrical forward path may comprise the core and/or armor layer. The at least one fiber reinforced composite material may be electrically conductive. The at least one fiber reinforced composite material may be a non-metallic material. The at least one fiber reinforced composite material may be a non-crystalline material. The electrical forward path may comprise the armor layer. The electrical forward path may comprise at least one segment of the armor layer. The cable may comprise at least one outer tube element. The electrical return path may comprise the at least one outer tube element. The cable may comprise at least one electrical insulator layer. The at least one electrical insulator layer may be located between the armor layer and the at least one outer tube element. The at least one electrical insulator layer may be located between the armor layer and the core. The cable may comprise two or more electrical insulator layers. A first electrical insulator layer may be located between the core and the armor layer. A second electrical insulator layer may be located between the armor layer and the at least one outer tube element.

Embodiments of the third aspect of the invention may include one or more features of the first or second aspects of the invention or their embodiments, or vice versa.

According to a fourth aspect of the invention, there is provided a wireline for a wellbore, comprising:
a core; and
an armor layer surrounding the core;
the armor layer comprises at least one fiber reinforced composite material;
wherein the armor layer comprises a plurality of segments configured to move along a longitudinal axis of the cable relative to one another.

Embodiments of the fourth aspect of the invention may include one or more features of any of the first to third aspects of the invention or their embodiments, or vice versa.

According to a fifth aspect of the invention, there is provided a method of manufacturing cable for a wellbore, comprising:
providing a core;
arranging an armor layer comprising a plurality of segments around the core to form an armor layer; and
wherein the armor layer comprises at least one fiber reinforced composite material.

The cable may comprise an electrical forward path and/or an electrical return path. The electrical forward path may comprise the core and/or armor layer. The at least one fiber reinforced composite material may be electrically conductive. The at least one fiber reinforced composite material may be a non-metallic material. The at least one fiber reinforced composite material may be a non-crystalline material. The electrical forward path may comprise the armor layer. The electrical forward path may comprise at least one segment of the armor layer. The cable may comprise at least one outer tube element. The electrical return path may comprise the at least one outer tube element. The cable may comprise at least one electrical insulator layer. The at least one electrical insulator layer may be located between the armor layer and the at least one outer tube element.

The method may comprise providing a plurality of first segments comprising a first type of fiber reinforced composite material and a plurality of second segments comprising a second type of fiber reinforced composite material.

The method may comprise arranging the plurality of first segments and the plurality of second segments around the core. The method may comprise arranging the plurality of first segments and the plurality of second segments in an alternating arrangement around the outer surface of the core.

The method may comprise inserting at least one reinforcement member into at least one segment. The method may comprise inserting at least one reinforcement member made of at least one fiber reinforced composite material into at least one segment. The segment may be made from a polymer or a fiber reinforced composite material. The method may comprise inserting at least one conductor into the at least one segment.

The method may comprise inserting at least one reinforcement member into first and/or second fiber reinforced composite material.

The method may comprise forming the segments by extrusion and/or pultrusion. The method may comprise pulling reinforced material through a dye or guide. The method may comprise orientating the fibers in relation to the profile cross-section. The method may comprise orientating the fibers to generally align with the longitudinal axis of the material. The method may comprise impregnating the fibers with a matrix material such as resin. The method may comprise pulling the resin impregnated fibers though a die. The dye may have shape to provide the desired profile shape of the segments.

The method may comprise curing the resin impregnated fibers in the desired profile shape and/or geometry. The method may comprise cutting cured resin impregnated fibers into a plurality of segments. The method may comprise separating the plurality of segments into individual segments and arranging the segments around the outer layer of core. The method may comprise surrounding the plurality of segments with an electrical insulator layer. The method may comprise surrounding electrical insulator layer with an outer tube element.

Embodiments of the fifth aspect of the invention may include one or more features of any of the first to fourth aspects of the invention or their embodiments, or vice versa.

According to a sixth aspect of the invention, there is provided a method of manufacturing cable for a wellbore, comprising:
providing a cable core; and
applying an armor layer surrounding the core by abutting a plurality of segments to encapsulate the cable core;
wherein the armor layer comprises at least one fiber reinforced composite material.

The fiber reinforced composite material may be processed by orienting fibers along a longitudinal axis and applying a thin layer directly on the fiber strands before arranging or applying a polymer layer. The strands may be arranged into segments.

The plurality of segments may be configured to distribute tensile forces along the length of the cable.

The plurality segments may be arranged around the core. The plurality segments may be arranged parallel with the longitudinal axis of the cable and/or core. The plurality segments may be arranged helically stranded around the core. The fiber reinforced composite material may be a carbon, aramid, graphene, basalt, or Kevlar material.

Embodiments of the sixth aspect of the invention may include one or more features of any of the first to fifth aspects of the invention or their embodiments, or vice versa.

According to a seventh aspect of the invention, there is provided a method of supporting a downhole device, comprising:
attaching the downhole to a cable, the cable comprising:
a core; and
an armor layer surrounding the core;
wherein the armor layer comprises at least one fiber reinforced composite material and
wherein the armor layer comprises a plurality of segments.

The core may comprise at least one conductor and/or at least one optical fiber. The method may comprise transmitting a signal to the downhole device via the cable. The method may comprise transmitting a signal to the downhole device via the core and/or the armor layer. The method may comprise receiving a signal from the downhole device via the cable. The method may comprise receiving a signal from the downhole device via an outer tube element of the cable. The method may comprise manoeuvring, actuating and/or controlling the downhole device via the cable.

Embodiments of the seventh aspect of the invention may include one or more features of any of the first to sixth aspects of the invention or their embodiments, or vice versa.

According to an eighth aspect of the invention, there is provided a cable for a wellbore, comprising:
a core; and
an armor layer surrounding the core;
wherein the armor layer comprises two or more segments;
wherein at least one segment comprises a reinforcement member;
wherein at least one segment and/or the reinforcement member comprises at least one fiber reinforced composite material.

The two or more segments may be configured to move along a longitudinal axis of the cable relative to one another.

The cable may comprise an electrical forward path and/or an electrical return path. The electrical forward path may comprise the core and/or at least one segment of the armor layer. The at least one fiber reinforced composite material may be electrically conductive. The reinforcement member may be electrically conductive. The at least one fiber reinforced composite material and/or the reinforcement member may be a non-metallic material. The at least one fiber reinforced composite material and/or the reinforcement member may be a non-crystalline material. The electrical forward path may comprise the armor layer. The electrical forward path may comprise at least one segment of the armor layer. The electrical forward path may comprise at least one reinforcement member. The cable may comprise at least one outer tube element. The electrical return path may comprise the at least one outer tube element. The cable may comprise at least one electrical insulator layer. The at least one electrical insulator layer may be located between the armor layer and the at least one outer tube element.

Embodiments of the eighth aspect of the invention may include one or more features of any of the first to seventh aspects of the invention or their embodiments, or vice versa.

According to a ninth aspect of the invention, there is provided a cable for a wellbore, comprising:
a core; and
an armor layer surrounding the core;
wherein the armor layer comprises at least one electrically conductive material;
wherein the armor layer is an electrical forward path.

The cable may comprise at least one outer tube element. The at least one outer tube element may be configured to provide an electrical return path. The cable may comprise at least one electrical insulator layer. The at least one electrical insulator layer may be located between the armor layer and the at least one outer tube element. The at least one electrical insulator layer may be located between the core and the armor layer.

The armor layer may comprise a single element. The armor layer may comprise a single solid body. The armor layer may comprise a homogenic cylinder. The armor layer may comprise a single solid cylindrical body. The single solid cylindrical body of the armor layer may surround the core.

The armor layer may comprise a composite material. The composite material may be a fibre-reinforced composite material. The composite material may be selected from carbon fiber, basalt fiber, natural mineral fiber, graphene, aramid fiber, or Kevlar fiber-based material. The fiber reinforced composite material may be resin impregnated. The fiber reinforced composite material may be configured for spatial efficiency in the cross section. By spatial efficiency it is meant that the space in the cross-section is filled with as much fibrous material possible in that space to avoid voids.

The armor layer may comprise two or more segments. The armor layer may comprise at least one first segment comprising a first segment material and at least one second segment comprising a second segment material. At least one segment may comprise a reinforcement member. At least one of the two or more segments and/or the reinforcement member may comprise an electrically conductive composite material. At least one of the two or more segments and/or the reinforcement member may comprise the electrical forward path.

Each of the segments may comprise the same composite material. Each of the segments may comprise the same fiber reinforced composite material. The plurality of segments may comprise segments made from different fiber reinforced composite material. The armor layer may comprise segments made of different composite material and/or different fiber reinforced composite material.

The armor layer may comprise a plurality of segments made of a fiber reinforced composite material having one tensile elasticity or Young's modulus. The armor layer may comprise a plurality of segments made of a fiber reinforced composite material having a tensile elasticity or Young's modulus in the range of 50 to 500 GPa.

The armor layer may comprise a mixture segments made of different materials. The armor layer may comprise a mixture segments made of different materials with each segment type having a set tensile elasticity or Young's modulus value. The armor layer may comprise a plurality of segments made of at least one segment type. The armor layer may comprise a plurality of segments made of one material and/or fibrous composition.

The armor layer may comprise segments of two or more fiber reinforced composite material. The two or more fiber reinforced composite materials may have a different tensile elasticity or Young's modulus values from one another. The tensile elasticity or Young's modulus values may be in the range of 50 to 500 GPa.

Embodiments of the ninth aspect of the invention may include one or more features of any of the first to eighth aspects of the invention or their embodiments, or vice versa.

According to a tenth aspect of the invention, there is provided a cable for use in a wellbore, comprising:
a core;
an armor layer surrounding the core; and
an outer encapsulation tube;
wherein the armor layer comprises an electrically conductive material; and
wherein the armor layer is an electrical forward path.

The outer encapsulation tube may comprise an electrically conductive material. The outer encapsulation tube may be an electrical return path. The armor layer may comprise at least one fiber reinforced composite material. The armor layer may comprise a plurality of segments. The outer encapsulation tube may surround or at least partially surround the armor layer.

Embodiments of the tenth aspect of the invention may include one or more features of any of the first to ninth aspects of the invention or their embodiments, or vice versa.

According to an eleventh aspect of the invention, there is provided a cable for use in a wellbore, comprising:
a core; and
an armor layer surrounding the core;
wherein the armor layer comprises a plurality of segments;
wherein at least one segment comprises non-metallic material;
wherein each segment is configured to be axially displaceable along a longitudinal axis of the cable relative to one another.

The cable may be selected from the group of a slickline, wireline, electrical cable, a non-electrical cable and/or an optical fiber cable.

The core may comprise at least one conductor and/or at least one optical fiber. The core may comprise at least one tubular element configured to surround the at least one conductor and/or the at least one optical fiber.

Each of the segments may abut the at least one tubular element. At least one segment of the armor may comprise a non-metallic electrically conductive material. Two or more segments of the armor may comprise a non-metallic electrically conductive material. All segments of the armor may comprise a non-metallic electrically conductive material. The armor layer may comprise at least one fiber reinforced composite material. The fiber reinforced composite material may be selected from carbon fiber, carbon-tube composite materials, basalt fiber, natural mineral fiber, graphite, graphene, graphene and/or graphite and graphene based composite materials, aramid fiber, and/or Kevlar fiber-based material.

The cable may comprise an electrical forward path comprising at least one segment of the armor layer. The cable may comprise an electrical return path comprising the outer encapsulation tube. The segments have a profile or cross section selected from group of keystone, square, circular, rectangular, wedged, round, non-circular or arc shape.

The plurality of segments may be arranged or orientated parallel with the longitudinal axis of the cable and/or the core. The plurality of segments may be arranged helically around the core. The at least one of the segments has at least one reinforcement member.

The fiber reinforced composite material may be provided in the form of a reinforcement member in one of more the segments. The at least one of the reinforcement member may be made of an electrically conductive non-metallic material. The armor layer may comprise at least one first segment comprising a first material and/or fibrous composition and at least one second segment comprising a second material and/or fibrous composition. The plurality of the segments may not be bonded to the core.

Embodiments of the eleventh aspect of the invention may include one or more features of any of the first to tenth aspects of the invention or their embodiments, or vice versa.

According to a twelfth aspect of the invention, there is provided a method of manufacturing cable for a wellbore, comprising:
providing a core;
arranging a plurality of segments around the core to form an armor layer wherein each segment is configured to be axially displaceable along a longitudinal axis of the cable relative to one another;
wherein at least one segment of the armor layer comprises a non-metallic material.

Embodiments of the twelfth aspect of the invention may include one or more features of any of the first to eleventh aspects of the invention or their embodiments, or vice versa.

### BRIEF DESCRIPTION OF THE DRAWINGS

There will now be described, by way of example only, various embodiments of the invention with reference to the drawings, of which:

FIG. 1 is a schematic partial cross-sectional view of a cable system in accordance with an embodiment of the present invention deployed in a wellbore;

FIG. 2 show a partially exploded perspective view of a cable according to an embodiment of the invention;

FIG. 3 shows a partially exploded perspective view of a cable according to an embodiment of the invention where the armor layer comprises segments of different material types;

FIG. 4 shows a partially exploded perspective view of a cable according to an embodiment of the invention where the armor layer comprises six segments wherein three segments comprise reinforcement members;

FIG. 5 shows a partially exploded perspective view of a cable according to another embodiment of the invention where the segments in the armor layer comprise a reinforcement member of different material type; and

FIG. 6 shows a partially exploded perspective view of a cable according to another embodiment of the invention the armor layer comprises alternating segments of different material types and reinforcement members of different material type;

FIG. 7 show a partially exploded perspective view of a cable according to another embodiment of the invention with forward and electrical return path identified; and

FIG. 8 show a partially exploded perspective view of a cable according to an embodiment of the invention with forward and electrical return path identified and a segmented armor layer.

### DETAILED DESCRIPTION OF PREFERRED EMBODIMENTS

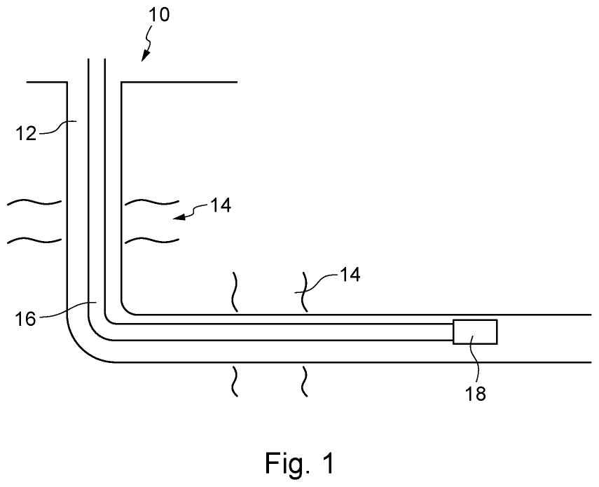

FIG. 1 is a simplified section through a vertical well 10. The well 10 has a wellbore 12, which passes through various reservoir formations 14. A cable system 16 such as slickline or wireline is used to transport and/or control a downhole device 18 such as a packer, plug etc. The downhole device is lowered on the cable system to a desired depth and set and/or actuated. The downhole device may be set and/or actuated by transmitting signals through the cable system or by exerting a force on the cable.

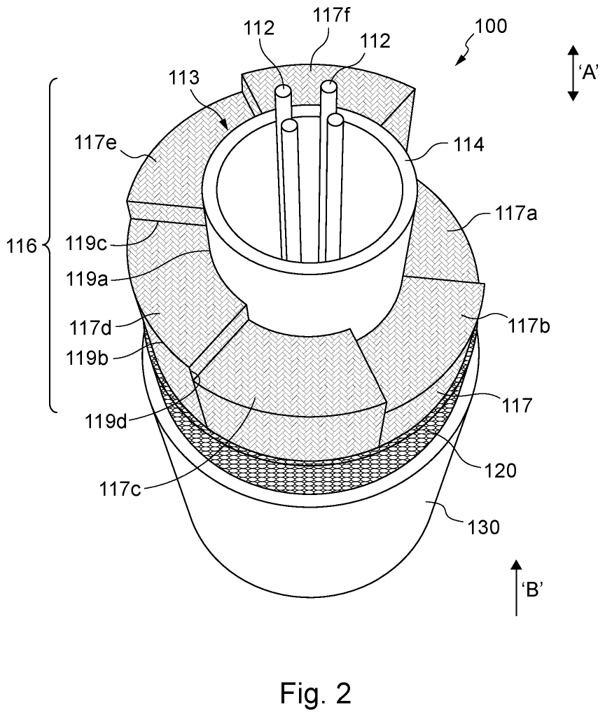

FIG. 2 is a partially exploded perspective view of a wireline cable 100 used to transport and/or control downhole well equipment in the wellbore 10 of FIG. 1. The wireline cable has conductors 112 at its core 113. In this example the conductors are electrical conductors are made of copper wire. The conductor 112 are configured to transmit power to a downhole device and/or transmit data to and from the surface. It will be appreciated that additionally or alternatively the core 113 may contain one or more optical fibers.

The conductor 112 are surrounded by a metal tube 114. In this example the metal tube is a thin walled tube of stainless steel. However, it will be appreciated that other types of metal or other types of material may be used. The metal tube 114 protects the enclosed conductors 112 from damage and degradation.

The metal tube 114 is surrounded by an armor layer 116. The armor layer comprises a plurality of segments 117 which surround the metal tube 114. Each of the segments 117a to 117f are free to move along the longitudinal axis of the cable relative to one another as shown by arrow “A” in FIG. 2. As shown in example of FIG. 2 starting from the position of segment 116a, each of the sequential segments 117b to 117f are shown as been axially displaced along the longitudinal axis of the cable in direction “B” by increasing distances. The ability of the segments 117a to 117f to move relative to one another provides the cable with increased flexibility and small bending radius.

The segments 117a to 117f are made of a high tensile strength, high elastic modulus, and low weight fibrous material. In this example the armor layer is made from segments of carbon fiber. However, it will be appreciated that the armor layer may be made of low weight segments of alternative material such as basalt fiber, pultruded fibers, or Kevlar fiber-based material. It will be appreciated that other types of materials and compositions may form the segments in other embodiments of the cable.

It will be appreciated that one or more segments of the armor layer may be made of an electrically conductive material. The conductors 112, metal tube of the core and/or one or more segments of the armor layer may provide or act as an electrical forward path. The conductors 112, metal tube of the core and/or one or more segments of the armor layer may transmit electrical signals through the cable.

Each of the segments have a keystone or wedge shape with four abutment surfaces 119a to 119d. A first abutment surface 119a contacts the metal tube 114. A second abutment surface 119b contacts a bundling element 120 in this example made of a thin polymer jacket. The segments are made of a low friction material that allows the abutments surfaces 119a and 119b to move relative to the metal tube 114 and the bundling element 120.

Each segment has a third and fourth abutment surface 119c, 119d. The third abutment surface 119c contacts an adjacent segment on one side of the segments and the fourth abutment surface 119d contacts an adjacent segment on an opposing side of the segment.

In use, any compression force acting on the armor layer is transferred from a segment to its adjacent segments distributing the compression force around the entire armor layer. The keystone or wedge shape of the segments prevents distortion or compression of the armor layer and protects the core and conductors therein.

The segments are surrounded by the bundling element 120. The bundling element assists in maintaining the radial positions of the segments relative to the core. In this example the bundling element 120 is a thin polymer jacket. However, alternatively tape may be used. The bundling element is configured such that it has low friction with the encased plurality of segments to allow the segments to be axially displaced relative to the bundling element with minimal resistance.

An outer encapsulation tube 130 made from metal or plastic polymer surrounds the bundling element 120 and provides protection to the cable and provides mechanical wear resistance to the wireline 100. In this example the outer encapsulation tube is made from a thermoplastic polymer.

It will be appreciated that the outer encapsulation tube may provide or act as a return path for electrical signals. A metal outer encapsulation tube 130 made from metal is conductive to electrical signals. It will be appreciated that if the outer encapsulation tube is made of a polymer then at least one conductor may be embedded or associated with the outer encapsulation tube to provide an electrical return path. The bundling element 120 located between the armor layer and the outer encapsulation tube is an electrical insulator layer.

In the above example the core is described as comprising electrical conductors in the form of wires. However, it will be appreciated that the electrical conductor may comprise different forms and additionally or alternatively the core may comprise one or more optical fibers.

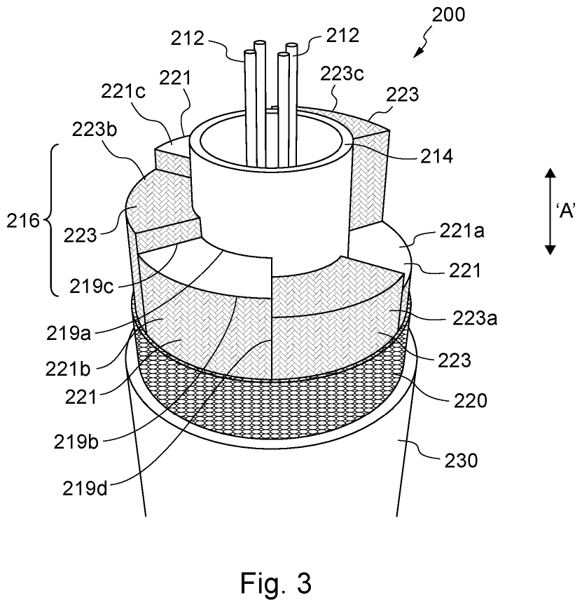

FIG. 3 is a partially exploded perspective view of a wireline cable 200 according to an embodiment of the present invention. The wireline cable 200 is similar to the wireline cable 100 described in FIG. 2 and will be understood from the description of FIG. 2. However, the armor layer 216 described in FIG. 3 is composed of six alternating segments 221 and 223 made of a different fibrous material.

The armor layer 216 has a similar overall structure as the armor layer 116 described in FIG. 2. The armor layer comprises a three first segments 221 made of a first material and three second segments 223 made of a second material. The first segments and second segments are arranged in an alternating arrangement around the metal tube 214.

Each of the segments are free to move along the longitudinal axis of the cable relative to one another as shown by arrow “A” in FIG. 3.

The first segments 221a to 221c are made of a first carbon fiber material having a modulus of elasticity of up to 500 GPa. The second segments 223a to 223c are made of a second carbon fiber material having a modulus of elasticity of approximately 150 GPa. The first and second segments may have different electrical properties such as electrical conductance and resistance.

Each of the segments 221, 223 have a keystone or wedge shape with four abutment surfaces 219a to 219d. The first abutment surface 219a of the segments 221, 223 contact the metal tube 214. The second abutment surface 219b of the segments 221, 223 contact a bundling element 220.

Each of the first segments 221 has a third and fourth abutment surface 219c, 219d. The third abutment surface 219c contacts an adjacent second segment 223 on one side of the first segment 221 and the fourth abutment surface 119d contacts an adjacent second segment on an opposing side of the first segment 221.

By providing a cable with an armor layer made of a plurality of first segment 221a to 221c and a plurality 223a to 223c with different elastic module and able to move relative to one another provides the cable with increased flexibility and small bending radius.

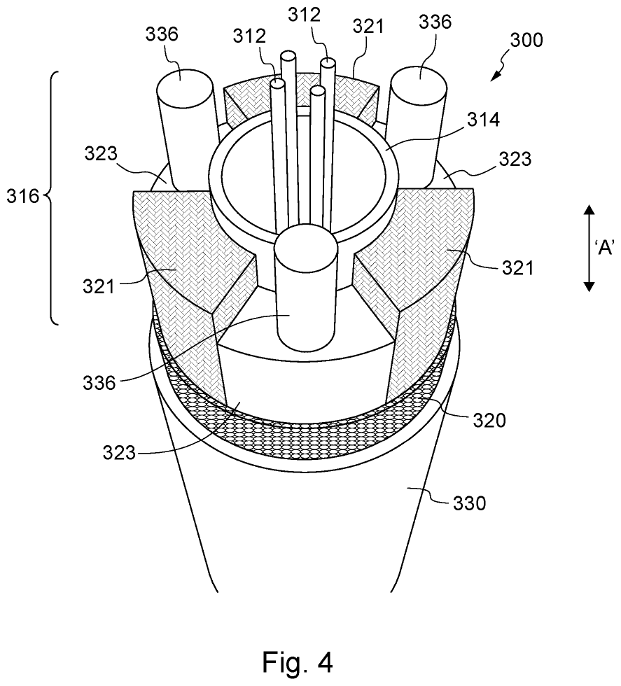

FIG. 4 is a partially exploded perspective view of a wireline cable 300 according to an embodiment of the present invention. The wireline cable 300 is similar to the wireline cable 200 described in FIG. 3 and will be understood from the description of FIG. 3. However, the armor layer 316 described in FIG. 4 is composed of alternating first segments 321 and second segments 323 made of material and each of the second segments 323 contains a reinforcement member 336.

The armor layer 316 has a similar overall structure as the armor layer 216 described in FIG. 3. The armor layer comprises three first segments 321 made of a first material and three second segments 323 made of a second material. The first segments and second segments are arranged in a periodic alternating arrangement around the metal tube 314. Each of the segments are free to move along the longitudinal axis of the cable relative to one another as shown by arrow “A” in FIG. 4. The first segments 321 are made of a fiber reinforced composite material in this example the fiber reinforced composite material is made of carbon fiber material. The second segments 323 are made of a polymer material. The second segments have a reinforcement member encapsulated in the second segments. The reinforcement member is made of a fiber reinforced composite material in this example the fiber reinforced composite material is made of carbon fiber. The reinforcement member provides additional strength to the cable.

It will be appreciated that the reinforcement material may be made of an alternative material such as a conductor, carbon rod, basalt rod or a fiber reinforced plastic and/or fiber reinforced composite material. The fibre reinforced composite material may be made of carbon, aramid, graphene, basalt, or Kevlar material. The fiber reinforced plastic may be produced in extrusion or pultrusion.

By providing a cable with an armor layer made of a plurality of first segments 321 and a plurality of second segments 323 with different elastic module and able to move relative to one another provides the cable with increased flexibility and small bending radius. Additional strength is provided to the cable by the inclusion of the reinforcement members to the second segments only.

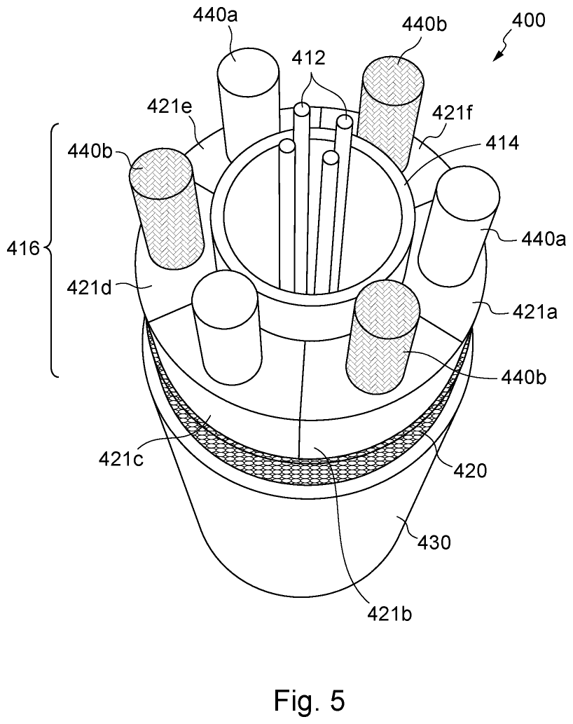

FIG. 5 is a partially exploded perspective view of a wireline cable 400 according to an embodiment of the present invention. The wireline cable 400 is similar to the wireline cable 100 described in FIG. 2 and wireline cable 200 described in FIG. 3 and will be understood from the description of FIGS. 2 and 3. However, the armor layer 416 described in FIG. 5 is composed of six segments 421a to 421f made of a polymeric material where each of the segments contains either a first reinforcement member 440a made of fiber reinforced composite material in this example the fiber reinforced composite material is made of carbon fiber or a second reinforcement member 440b made of a steel wire encapsulated in each segment.

The armor layer 416 has a similar overall structure as the armor layer 316 described in FIG. 3. The armor layer comprises a plurality of segments 421 made of a fibrous material. The segments 421a, 421c and 421e each comprise a first reinforcement member 440a made of carbon fiber having a modulus of elasticity of 0.1 Gpa to 5 GPa.

The segments 421b, 421d and 421f each comprise a second reinforcement member 440b made of steel wire having a modulus of elasticity of 100 Gpa to 500 GPa.

It will be appreciated that the reinforcement material may be made of an alternative material such as a conductor, carbon rod, basalt rod or a fiber reinforced plastic. The fiber reinforced plastic may be produced in extrusion or pultrusion.

The reinforcement members 440a, 440b provides additional strength to the cable. The first reinforcement members and second reinforcement members are arranged in an alternating segment arrangement around the metal tube 314.

By providing a cable with an armor layer made of a plurality of segments 421a, 421c and 421e each comprising a first reinforcement member 440a and a plurality of segments 421b, 421d and 421f each comprising a second reinforcement member 440b with different elastic module and able to move relative to one another provides the cable with increased flexibility and small bending radius. Additional strength is provided to the cable by the inclusion of the reinforcement members.

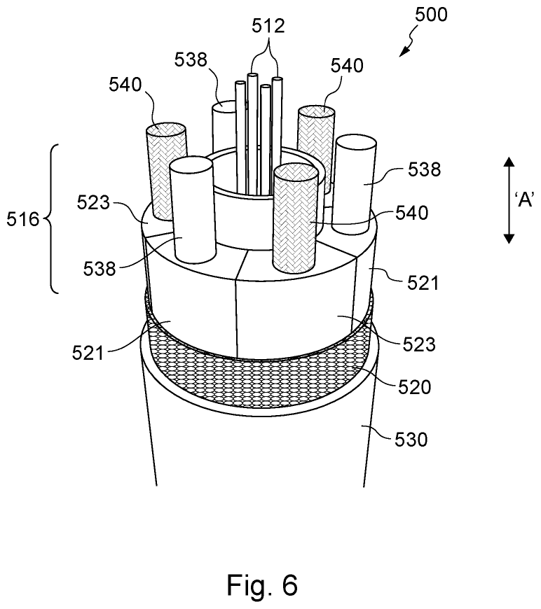

FIG. 6 is a partially exploded perspective view of a wireline cable 500 according to an embodiment of the present invention. The wireline cable 500 is similar to the wireline cable 300 described in FIG. 4 and will be understood from the description of FIG. 4.

However, the armor layer 516 described in FIG. 6 is composed of a three first segments 521 and three second segments 523. The plurality of first segments 521 and 523 are made of a polymer composition such as silicone. However, it will be appreciated that alternative polymeric materials may be used including copolymer and fluoropolymer, silicone and ceramic and/or natural mineral buffer materials. Each of the first segments contain a first reinforcement member 538 and each of the second segment contains a second reinforcement member or conductive element 540.

The armor layer 516 has a similar overall structure as the armor layer 516 described in FIG. 3. The armor layer comprises a plurality of first segments 521 made of a first material and a plurality of second segments 523 made of a second material. The first segments and second segments are arranged in an alternating arrangement around the metal tube 514. Each of the segments are free to move along the longitudinal axis of the cable relative to one another as shown by arrow “A” in FIG. 6.

The first segments 521 are made of a polymer material. Each of the first segments have a first reinforcement member in this example steel wire encapsulated in the polymer material first segment.

The second segments 523a to 523c are made of a polymer composition such as silicone. Each of the second segments have a second reinforcement member in this example fiber reinforced composite material. In this example the fiber reinforced composite material is made of carbon. However, it will be appreciated that other forms of fiber reinforced composite material including graphene or natural mineral fiber may be used.

By providing a cable with an armor layer made of a plurality of first segment 521 and a plurality 523 with different elastic modulus and able to move relative to one another provides the cable with increased flexibility and small bending radius. Additional strength is provided to the cable by the inclusion of the reinforcement members in the first and second segments only.

In the above examples the armor layer is shown to comprise six segments. However, it will be appreciated that the armor layer may have any number of segments greater than two.

It will be appreciated that in the above examples the cable (100, 200, 300, 400, 500) may have an electrical forward and/or return path. One or more segments of the armor layer may be made of, or comprise an electrically conductive material. The conductors, metal tube of the core and/or one or more segments of the armor layer may provide or act as an electrical forward path. If the one or more segments are made of different materials they may have different electrical properties such as electrical conductance and resistance. If the one or more segments have at least one reinforcement members or at least one reinforcement member of a different material the segments may have different electrical properties including electrical conductance and resistance. By providing different combinations of armor segment materials in the armor layer and/or the presence or absence of reinforcement members of different material types may facilitate a wide range of electrical, strength and flexibility properties and allow a cable to be designed for a particular downhole application.

It will be appreciated that an electrical return path may be provided by the outer encapsulation tube. The outer encapsulation tube (130, 230, 330, 430, 530) may be made from metal or polymer. A metal outer encapsulation tube is conductive to electrical signals. It will be appreciated that if the outer encapsulation tube is made of a polymer then at least one conductor may be embedded or associated with the outer encapsulation tube to provide an electrical return path. An insulation layer such as the bundling element 120, 220 320, 420, 520 located between the armor layer and the outer encapsulation tube isolates the forward and return paths.

It will also be appreciated that at least one reinforcement member may provide or act as an electrical forward path.

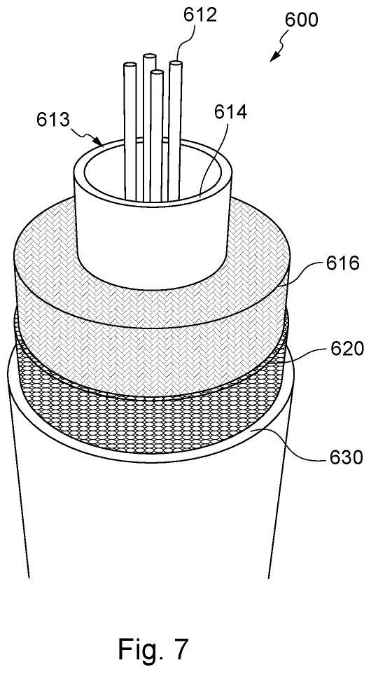

FIG. 7 is a partially exploded perspective view of a cable 600. The cable has conductors 612 at its core 613. In this example the conductors are electrical conductors are made of copper wire. The conductor 612 are configured to transmit power to a downhole device and/or transmit data to and from the surface. It will be appreciated that additionally or alternatively the core 613 may contain one or more optical fibers.

The conductor 612 are surrounded by a metal tube 614. In this example the metal tube is a thin walled tube of stainless steel. However, it will be appreciated that other types of metal or other types of material may be used. The metal tube 614 protects the enclosed conductor 612 from damage and degradation.

The metal tube 614 is surrounded by an armor layer 616. The armor layer comprises a layer of high tensile strength, high elastic modulus, and low weight electrically conductive composite material which surround the metal tube 614. The armor layer 616 is not bound to the metal tube 614 which enables the armor layer to move relative to metal tube 614 and the core which provides the cable with increased flexibility and small bending radius.

In this example the armor layer is made from a cylinder of carbon fiber. However, it will be appreciated that alternative material such as carbon-tube composite materials, basalt fiber, natural mineral fiber, graphite, graphene, graphene and/or graphite and graphene based composite materials which either conduct electricity or comprise one or more conductors that conduct electricity.

The conductors 612, metal tube 614 of the core and/or the armor layer 616 may provide or act as an electrical forward path. The conductors 612, metal tube of the core and/or the armor layer may transmit electrical signals through the cable. By providing an electrical forward path comprising an armor layer having a single cylindrical layer of large cross sectional area facilitates high conductance and low resistance in the electrical forward path.

The armor layer is surrounded by an electrical insulator layer 620. In this example the electrical insulator layer 620 is a thin polymer jacket. Alternatively or additionally the electrical insulator layer may be in the form of a tape a layered coating or buffer material. In this example the electrical insulator layer is located between the armor layer and an outer encapsulation layer 630. Alternatively or additionally one or more electrical insulator layers may be provided between the core and the armor layer where the metal tube would be surrounded by an electrical insulator layer.

An outer encapsulation tube 630 made from metal or plastic polymer surrounds the insulation layer 620. The outer encapsulation tube 630 provides protection to the cable. It provides cable with tensile strength and lateral gas/liquid hermeticity and provides mechanical wear resistance to the cable 600.

In this example the outer encapsulation tube is made from a metal tube or cylinder. The outer encapsulation tube is made of a conductive metal material provides or acts as a return path for electrical signals.

The material, dimensions and wall thickness of the outer encapsulation tube is selected to provide optimum electrical performance, mechanical flexibility and tensile strength. The material dimensions and wall thickness are selected to provide a low resistance electrical return path.

In the above example the electrical forward path and the electrical return path are made of different materials with a non-metallic forward path and a metallic return path. By providing different combinations of metallic or non-metallic forward path or metallic return paths allows cables to be designed for a particular purpose and having specific electrical, strength, weight and flexibility properties.

It will be appreciated that the forward path may be made of a metallic material and that the return path may be made of a non-metallic material. It will be appreciated that the components providing the electrical forward path and the electrical return path may be made of the same material.

The electrical insulator layer electrically separates the cross-section of the cable into two concentric co-axial electrical paths i.e. a forward path and a return path.

In the above example the core is described as comprising electrical conductors in the form of wires. However, it will be appreciated that the electrical conductor may comprise different forms and additionally or alternatively the core may comprise one or more optical fibers.

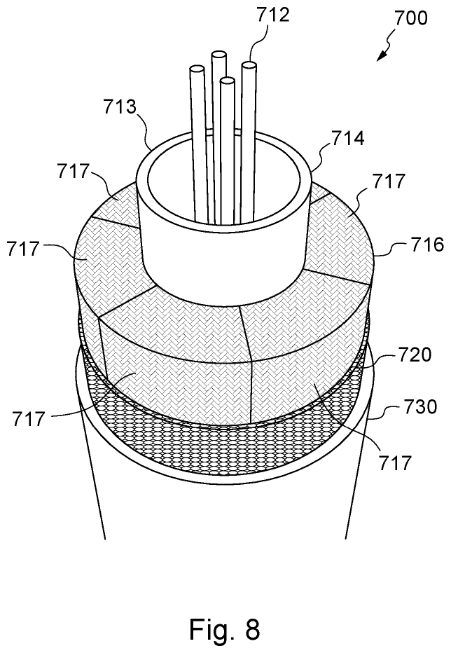

FIG. 8 is a partially exploded perspective view of a cable 700. The cable 700 is similar to the wireline cable 600 described in FIG. 7 and will be understood from the description of FIG. 7. However, the armor layer 716 described in FIG. 8 is composed of multiple segments in this example six segments 717 made of an electrically conductive carbon fiber material.

It will be appreciated that the armor layer may be made of low weight segments of alternative material such as electrically conductive material comprising carbon-tube composite materials, basalt fiber, natural mineral fiber, graphite, graphene, graphene and/or graphite and graphene based composite materials. It will be appreciated that other types of materials and compositions may form the segments in other embodiments of the cable.

The conductors 712, metal tube of the core and/or one or more segments of the armor layer may provide or act as an electrical forward path. The conductors 712, metal tube of the core and/or one or more segments of the armor layer may transmit electrical signals through the cable. By providing an electrical forward path comprising one or more segments of the armor layer the cross sectional area of the electrical forward path is large and facilitates high conductance and low resistance.

The armor layer composes of multiple segments is surrounded by an electrical insulator 35 layer 720. In this example the electrical insulator layer 720 is a thin polymer jacket.

Alternatively or additionally the electrical insulator layer may be in the form of a tape a layered coating or buffer material. In this example the electrical insulator layer is located between the armor layer and an outer encapsulation layer 730. Alternatively or additionally one or more electrical insulator layers may be provided between the core and the armor layer where the metal tube would be surrounded by an electrical insulator layer.

The segments 717 are not bound to one another or to the metal tube 714 or surrounding electrical insulator layer 720. This allows the segments 717 to move relative to one another and relative to the metal tube 714 and the electrical insulator layer 720.

An outer encapsulation tube 730 made from metal or plastic polymer surrounds the insulation layer 720. The outer encapsulation tube 730 provides protection to the cable. It provides cable with tensile strength and lateral gas/liquid hermeticity and provides mechanical wear resistance to the cable 700. In this example the outer encapsulation tube is made from a metal tube or cylinder. The outer encapsulation tube is made of a conductive metal material provides or acts as a return path for electrical signals.

In the above example the electrical forward path and the electrical return path are made of different materials with a non-metallic forward path and a metallic return path. By providing different combination of metallic or non-metallic forward path and/or a metallic return path

The material, dimensions and wall thickness of the outer encapsulation tube may be selected to provide optimum electrical performance, mechanical flexibility and tensile strength properties to the cable. The material dimensions and wall thickness are selected to provide a low resistance electrical return path. By providing different combinations of metallic or non-metallic forward path or metallic return paths allows cables to be designed for a particular purpose and having specific electrical, strength, weight and flexibility properties.

It will be appreciated that the forward path may be made of a metallic material and that the return path may be made of a non-metallic material. It will be appreciated that the components providing the electrical forward path and the electrical return path may be made of the same material.

The invention provides a cable for a wellbore comprising a core and an armor layer surrounding the core. The armor layer may be part of an electrical forward path. The cable may have an electrical return path arranged in a concentric configuration electrically separated from the electrical forward path by an insulator.

The armor layer may comprise a plurality of segments made of a fiber reinforced composite material. Each of the segments are configured to move along a longitudinal axis of the cable relative to one another.

The present invention relates generally to cables for application in oil and gas field, in particular retrievable cables but the present invention is not limited to oil or gas field only. The invention may provide a multilayer cable design involving composite and/or metallic materials. Each of the cable elements are not bonded which facilitates flexibility and bending of the cable which may offer a longer working lifespan. The invention may provide a cable which has a high tensile strength and low weight which may facilitate handing of long lengths of the cable. The qualities of the cable of the invention are beneficial for wellbore applications in particular horizontal or deviated bores where thousands of metre of cable may be required.

The strength to weight ratio of the cable allows the cable to be used for a number of tasks in deep wells. The high tensile strength of the cable is able to support a variety of downhole tools in addition to supporting the cable weight. The tasks may include carrying monitoring or operational tools on the lowered end, jarring operations, compensation of friction on retrieving and inclusion of other standard safety factors in the operations.

The present invention may provide the armor layer close to the core of the cable to provide strength and high spatial efficiency making the cable fluid tight. The invention may provide a cable which has an armor layer made of independently movable segments which provide the cable with flexibility and a large number of bending cycles on small bending radius. The cable may have a protective layer to allow it to be used in harsh conditions such as high pressure and temperature pressure (HPHT) and chemical aggressive environments.

The outer layer may provide the cable with a low friction and uniform roundness within tight tolerances to facilitate the movement the cable downhole. The outer layer may provide the cable with high tensile strength and/or lateral gas/liquid hermeticity. The armor layer and/or the outer tube element may prevent fluid ingress in high pressure and high temperature conditions protecting the core of the cable.

The cable of the present invention may not require a steel wire armor layer which mitigates torque imbalance or cable stretching. The ability of the cable to resist cable stretching and deformation allowing the cable to control mechanical operations and impulsive actions such as jarring. The low friction of the armor cable and/or the outer surface of the cable of the present invention allows passing of the cable downhole. This mitigates the problems of cable handling and may avoid the requirements to grease the cable to reduce friction, wear, and abrasion.

The material, dimensions and wall thickness of components of the cable including the armor layer and outer encapsulating tube may be selected to provide optimum electrical performance, mechanical flexibility and/or tensile strength properties to the cable. The material and dimensions of the armor layer may be selected to provide a low resistance and/or a low inductance electrical forward path. The material, dimensions and wall thickness of the outer encapsulation layer are selected to provide a low resistance electrical return path. By providing different combinations of metallic or non-metallic forward path or metallic return paths each having different materials and dimension may allow cables to be designed for a particular purpose and having specific electrical, strength, weight and flexibility properties. These may include cables having low electrical resistance and weight whilst providing high flexibility and strength.

The invention provides a cable for use in a wellbore. The cable comprises a core and an armor layer surrounding the core. The armor layer comprises a plurality of segments wherein at least one segment comprises non-metallic material. Each segment is configured to be axially displaceable along a longitudinal axis of the cable relative to one another.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

Furthermore, relative terms such as”, “lower”, “upper, “up”, “down”, above, below, inlet, outlet, upward, downward and the like are used herein to indicate directions and locations as they apply to the appended drawings and will not be construed as limiting the invention and features thereof to particular arrangements or orientations.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention herein intended.

1. A cable for use in a wellbore, comprising:
a core; and
an armor layer surrounding the core;
wherein the armor layer comprises a plurality of segments;
wherein at least one segment comprises non-metallic material;
wherein each segment is configured to be axially displaceable along a longitudinal axis of the cable relative to one another.

2. The cable according to claim 1 wherein the cable is selected from the group of a slickline, wireline, electrical cable, a non-electrical cable and/or an optical fiber cable.

3. The cable according to claim 1 wherein the core comprises at least one conductor and/or at least one optical fiber.

4. The cable according to claim 3 wherein the core comprises at least one tubular element configured to surround the at least one conductor and/or the at least one optical fiber.

5. The cable according to claim 4 wherein each of the segments abut the at least one tubular element.

6. The cable according to claim 1 wherein at least one segment of the armor layer comprises a non-metallic electrically conductive material.

7. The cable according to claim 1 wherein all segments of the armor layer comprise a non-metallic electrically conductive material.

8. The cable according to claim 1 comprising an electrical forward path comprising at least one segment of the armor layer.

9. The cable according to claim 1 comprising an electrical return path comprising the outer encapsulation tube.

10. The cable according to claim 1 wherein the segments have a profile or cross section selected from group of keystone, square, circular, rectangular, wedged, round, non-circular or arc shape.

11. The cable according to claim 1 wherein the plurality of segments is arranged or orientated parallel with the longitudinal axis of the cable and/or the core.

12. The cable according to claim 1 wherein the plurality of segments is arranged helically around the core.

13. The cable according to claim 1 wherein the armor layer comprises at least one fiber reinforced composite material.

14. The cable according to claim 13 wherein the fiber reinforced composite material is selected from the groups comprising carbon fiber, carbon-tube composite materials, basalt fiber, natural mineral fiber, graphite, graphene, graphene and/or graphite graphene based composite materials.

15. The cable according to claim 1 wherein at least one of the segments has at least one reinforcement member.

16. The cable according to claim 13 wherein the fiber reinforced composite material is provided in the form of a reinforcement member in one of more the segments.

17. The cable according to claim 15 claim wherein the at least one of the reinforcement member is made of an electrically conductive non-metallic material.

18. The cable according to claim 1 wherein the armor layer comprises at least one first segment comprising a first material and/or fibrous composition and at least one second segment comprising a second material and/or fibrous composition.

19. The cable according to claim 1 wherein the plurality of the segments is not bonded to the core.

20. A method of manufacturing cable for a wellbore, comprising:
providing a core;
arranging a plurality of segments around the core to form an armor layer wherein each segment is configured to be axially displaceable along a longitudinal axis of the cable relative to one another;
wherein at least one segment of the armor layer comprises a non-metallic material.

21. The method according to claim 20 comprising providing a plurality of first segments comprising a first type of fiber reinforced composite material and a plurality of second segments comprising a second type of fiber reinforced composite material.

22. The method according to claim 21 comprising arranging the plurality of first segments and the plurality of second segments in an alternating arrangement around the outer surface of the core.

23. The method according to claim 20 comprising inserting at least one reinforcement member into at least one segment.

24. The method according to claim 20 comprising forming the segments by extrusion and/or pultrusion.

25. The method according to claim 20 comprising pulling reinforced material through a dye or guide.
